(19) United States
(12) Patent Application Publication
(10) Pub. No.: US 2013/0295835 A1
(43) Pub. Date: Nov. 7, 2013

(54) AIR-CONDITIONING DEVICE

(71) Applicants: Maximilian Fleischer, Hoehenkirchen (DE); Johannes Reinschke, Nuremberg (DE)

(72) Inventors: Maximilian Fleischer, Hoehenkirchen (DE); Johannes Reinschke, Nuremberg (DE)

(73) Assignee: SIEMENS AKTIENGESELLSCHAFT, München (DE)

(21) Appl. No.: 13/996,464

(22) PCT Filed: Dec. 19, 2011
(86) PCT No.: PCT/EP11/73207

§ 371 Date: Jun. 20, 2013

(30) Foreign Application Priority Data
Dec. 20, 2010 (EP) 10 2010 063 539.1

(51) Int. Cl. F24F 11/02; G01N 21/17

(52) U.S. Cl. CPC F24F 11/022; G01N 21/17
USPC 454/256; 356/72

(57) ABSTRACT

A control/regulation unit and a sensor device in an air-conditioning device enable detecting presence of an analyte in room air to infer the quality of the room air. A light source emits light into the room on a light path that is reflected to a light-sensitive detector. The air-conditioning device is controlled/regulated as a function of an output of the detector. If the analyte is situated on the light path, the light is scattered and/or absorbed such that the detector detects a smaller quantity of light, on the basis of which it is possible to infer the presence of the analyte. The light source can be pivoted to set various light paths through the room to determine where the analyte is situated in the room based on the output of the detector for each light path. The air-conditioning device can controlled to selectively influence the atmospheric environment locally.

### CROSS REFERENCE TO RELATED APPLICATIONS

This application is the U.S. national stage of International Application No. PCT/EP2011/073207, filed Dec. 19, 2011 and claims the benefit thereof. The International Application claims the benefit of German Application No. 102010063539.1 filed on Dec. 20, 2010, both applications are incorporated by reference herein in their entirety.

### BACKGROUND

Described below is an air-conditioning device, e.g., an air-conditioning system for influencing the atmospheric environment in a room.

Air-conditioning systems including a fan, a controller/regulator and one or more sensors are normally used to provide air conditioning in rooms, e.g. in buildings or in vehicles such as cars, trains or airplanes. The sensor supplies a signal to the controller/regulator, the signal representing a measure of a variable which describes the atmospheric environment in the room, e.g. the temperature, the air humidity and/or the air quality. Depending on this signal, the controller/regulator influences the fan, which in turn can provide a specific airflow and adjust the properties of this airflow in respect of atmospheric environment. Temperature and air humidity in particular, and to a lesser extent the air composition if applicable, are influenced in this case.

In this case, a compromise must be found between
(a) the setting of the fresh-air supply, i.e. the quantity of fresh air that is supplied per time unit, and the associated energy consumption, and
(b) the air quality in the air-conditioned room.

The term air quality encompasses e.g. the CO2 concentration, odors and pollutants, dust, gas and vapors, etc. Specific atmospheric pollutants such as sulfur dioxide, nitrogen dioxide, nitrogen oxide, fine dust, lead, benzene, carbon monoxide, ozone, etc. can also be included in the evaluation of the air quality.

In order to provide customized air conditioning, the quality of the air in the room must be measured by corresponding sensors (e.g. gas sensors), provision usually being made for a plurality of sensors that are distributed in the room in order to determine the air quality in a plurality of different zones of the room. However, this arrangement only allows largely localized determination of the air quality. In order to obtain a largely continuous two-dimensional or three-dimensional picture of the air quality in the room, which would allow customized air conditioning, provision must be made for a multiplicity of sensors and the significant associated overheads in terms of installation and cost.

### SUMMARY

Described below are air-conditioning devices improved in a customized manner to the effect that the quality of the air in the room can be influenced not only at individual locations in the room but in a distributed manner in predefined parts of the room or ultimately even in the whole of the room.

An air-conditioning device for influencing the atmospheric environment in a room features a control and regulation unit and at least one sensor device.

The sensor device itself has a radiation source, e.g. a light source for visible and non-visible light, which emits radiation, e.g. in the form of light, on a beam path through the room or into the room during operation. The sensor device also includes a detector which is sensitive at least to the radiation that is emitted and diffusely reflected in the room.

The detector is arranged such that at least part of the radiation which is emitted by the radiation source during operation, and is diffusely reflected in the room, can fall directly or indirectly onto the detector. For example, the emitted light is reflected and/or scattered back at the room walls or other objects in the beam path, such that at least part of the emitted radiation can come back to the detector.

The detector produces an output signal which is dependent on the presence and/or concentration, in the beam path, of a specific analyte that is to be detected, and on a light quantity or an intensity of the radiation, originally emitted by the radiation source and diffusely reflected in the room, which falls on the detector. Analytes include e.g. H2O, CO2 and volatile, poisonous and/or explosive gases such as natural gas, methane, carbon monoxide and other substances that may be relevant to the air quality. The emitted radiation is at least partially absorbed, scattered and also reflected as a result of the presence of the analyte in the beam path, thereby reducing the intensity of the radiation falling back onto the detector. In this case, the degree of change in the output signal is dependent on the quantity and/or concentration of the analyte in the beam path.

The control and regulation unit is so configured as to control and/or regulate the air-conditioning device as a function of the output signal of the detector. This means that the control and regulation unit influences the air-conditioning device according to the output signal, wherein e.g. the strength of the airflow is regulated.

The propagation direction of the radiation can be pivoted over at least part of the room, such that various radiation paths through the room can be set. In this case, at least one output signal of the detector is determined for a plurality of the radiation paths that can be set, in particular for every radiation path that can be set.

It is therefore possible to determine the presence and/or concentration of the analyte not only at specific points, but also on at least one plane. Using the knowledge thus obtained in respect of the position of the analyte, it is possible to control and/or regulate the air-conditioning device such that the atmospheric environment can be influenced selectively at the location of the analyte. The air-conditioning device is therefore suitable for locally monitoring the quality of the air in the room.

The radiation source is so configured as to emit radiation on at least some of the various radiation paths simultaneously, the frequencies of the radiation emitted on the various radiation paths being varied according to radiation path. In order to achieve this, the radiation source can either include a plurality of individual radiation sources which are variously aligned such that the respectively emitted light is emitted on the different beam baths. Alternatively, the radiation source can be equipped with a suitable beam lens system, e.g. a mirror or the like, which spreads out a light beam that is emitted by the radiation source.

In an alternative embodiment, the various radiation paths are set and scanned sequentially, i.e. in a temporally consecutive manner.

It is essential in this context that the various radiation paths, or the presence and/or concentration of the analyte that is identified by the detector in respect of the various radiation paths, can be distinguished from each other. In other words, it must be possible to assign the presence and/or concentration of the analyte that is identified in each case to a specific radiation path.

The air-conditioning device may have at least two such sensor devices, which are positioned at different locations in the room. Each of the sensor devices is individually configured as described above in this case. In particular, this means that each of the sensor devices can emit radiation on a beam path through the room, the propagation direction of the respective radiation being pivotable over at least part of the room, such that various radiation paths through the room can be set, and at least one output signal of the detector is determined for a plurality of the radiation paths that can be set, in particular for every radiation path that can be set. Consequently, if e.g. two such sensor devices are present, the position of the analyte in the room can be determined two-dimensionally, such that the atmospheric environment can be influenced even more precisely.

In this case, the control and regulation unit is configured to calculate a two-dimensional map of the distribution of the analyte in the room, from the data that has been determined by the at least two sensor devices or from output signals of the detectors for the various beam paths.

The various sensor devices work at different frequencies, i.e. the radiation emitted by the various radiation sources during operation is characterized by different frequencies, such that mutual interference is prevented.

The room in which the air-conditioning device operates has a plurality of walls, in particular side walls, a floor and a ceiling. At least two of the various radiation sources are positioned on different walls of the room or possibly on the same wall of the room, in which case they occupy different positions on this wall. Only thus is it possible to ensure that the position of the analyte can be identified in at least two dimensions.

The radiation paths that can be set by the various radiation sources essentially lie on the same plane, this being essentially horizontal. Due to the normally three-dimensional extent of the analyte, it is not necessary for the planes to correspond exactly. However, the reliability with which the position can be determined increases with the degree of sameness of the planes.

The air-conditioning device further includes
a device for generating at least one airflow in the room, wherein the airflow can be adjusted in respect of atmospheric environment, and
at least one outlet opening, via which the at least one adjustable airflow can be directed into the room.

The control and regulation unit is designed to adjust the airflow coming into the room from the outlet opening as a function of the output signals of the detector as determined for the various radiation paths. It is thus possible to influence the atmospheric environment.

The device for generating the at least one adjustable airflow generates a number of separate airflows corresponding to the number of outlet openings. The atmospheric environment can then be influenced locally, i.e. in a specific room zone in which e.g. the analyte is located, as efficiently as possible.

The air-conditioning device may also include:
a device for generating at least one airflow out of the room, i.e. a fan having a suction effect, for example, and
at least one suction opening via which the at least one adjustable airflow can be sucked out of the room.

In this case, the control and regulation unit is designed to adjust the airflow leaving the room through the respective suction opening as a function of the output signals of the detector as determined for the various radiation paths.

The device for generating the at least one adjustable airflow from the room generates a number of separate airflows corresponding to the number of suction openings.

The frequency of the radiation which is emitted by the radiation source is selected such that the radiation passing through the analyte is at least partially absorbed and/or scattered. This ensures that the quantity of light falling back onto the detector is actually reduced if the analyte is present in the beam path, such that the analyte can be detected.

On the basis of the output signal of the detector, it is therefore possible directly to infer the presence or even the concentration of the analyte in the beam path.

The radiation source can be a laser diode or an LED, for example.

### BRIEF DESCRIPTION OF THE DRAWINGS

These and other aspects and advantages will become more apparent and more readily appreciated from the following description of the exemplary embodiment, taken in conjunction with the accompanying drawings of which:

FIG. 1 is a plan view of a room with an air-conditioning device,

FIG. 2 is a two-dimensional map of the distribution of an analyte in the room.

### DETAILED DESCRIPTION OF THE PREFERRED EMBODIMENT

Reference will now be made in detail to the preferred embodiments, examples of which are illustrated in the accompanying drawings, wherein identical or corresponding regions, components, or assemblies are denoted by the same reference characters.

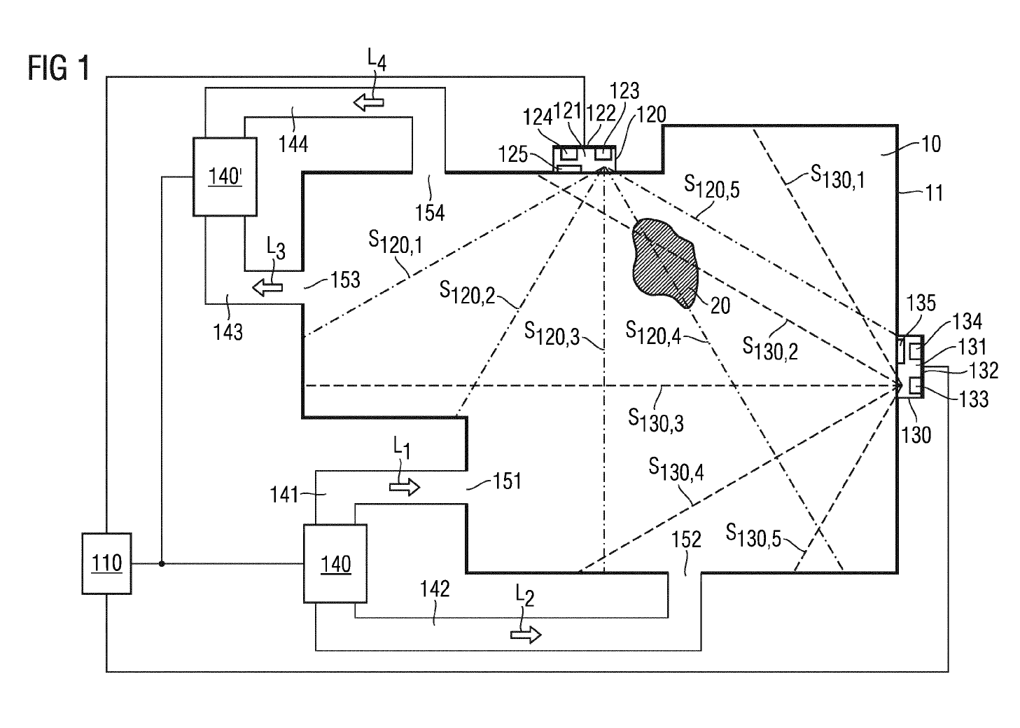

FIG. 1 shows a plan view of a room 10 in a building, e.g. a living room or a conference room, and an air-conditioning device 100, e.g. an air-conditioning system by which the atmospheric environment in the room can be influenced locally. The term “atmospheric environment” in this case can encompass the temperature and/or humidity of the air in the room as well as the air quality. For the purpose of evaluating the air quality, e.g. the CO2 concentration as well as odors and pollutants, dust, gases and vapors, etc. can be taken into consideration. Specific atmospheric pollutants such as sulfur dioxide, nitrogen dioxide, nitrogen oxide, fine dust, lead, benzene, carbon monoxide, ozone, etc. can also be included in the evaluation of the air quality. The terms “atmospheric environment” and “sensor” are used generally in the following, and without detailing the parameters that are to be measured in each case, since this has no bearing on the air-conditioning device described herein.

The air-conditioning device 100 includes a control and regulation unit 110, two sensor devices 120, 130, a device 140 for generating at least one airflow that can be adjusted in respect of atmospheric environment, e.g. a fan 140, two outlet openings 151, 152 and two suction openings 153, 154, via which the airflow of the fan 140 can be directed into or out of the room. The openings 151, 152, 153, 154 are connected to the fan 140 via channels 141, 142, 143, 144.

The fan 140, which is not illustrated in greater detail here, can not only generate an airflow of specific strength or a specific volume flow into the room and/or out of the room via the corresponding openings, but can also selectively influence the temperature, the humidity and optionally the air quality of the airflow, under the control of the control and regulation unit 110.

An airflow whose properties in respect of atmospheric environment are selectively adjustable can therefore be directed into the room via the outlet openings 151, 152, such that the atmospheric environment in the room can be influenced. By virtue of the fact that a plurality of outlet openings are provided and that the airflows entering the room through the various outlet openings can be adjusted individually and independently of each other if applicable, the atmospheric environment in the room can be influenced locally. This means that different conditions in respect of atmospheric environment can be generated at various locations in the room.

Air can be selectively and locally sucked out of the room by the suction openings 153, 154. This is particularly advantageous if e.g. a health-threatening gas or similar is located in the room. In such an event, the gas can be removed from the room by the fan 140, which then acts as a suction device, and that suction opening which is closest to the gas. Provision may be made for fresh air to be directed into the room via the outlet openings 151, 152 at the same time.

Two different approaches are conceivable in this case:

(1) The fan is so configured as to generate a plurality of separate airflows L1, L2, L3, L4 as illustrated in FIG. 1. The fan 140 is connected via separate channels 141, 142, 143, 144 to the openings 151, 152, 153, 154. The number of airflows that can be generated and the number of channels may correspond to the number of openings 151, 152, 153, 154. Firstly, the respective atmospheric environment of the individual airflows that are directed to the outlet openings 151, 152 can be adjusted independently of each other in this case. Provision is not made for influencing the atmospheric environment of the air that is sucked out of the room via the suction openings 153, 154. Secondly, it is possible to adjust the volume flows which must be transported to the outlet openings 151, 152 and from the suction openings 153, 154.

(2) The fan generates an airflow of a specific atmospheric environment and the outlet openings 151, 152 into the room are separately activated such that the airflow entering the room from the individual openings 151, 152 can be controlled separately. Depending on the requirement, e.g. the first opening 151 can be opened, by suitable adjustable flaps or the like, wider than the second opening 152, such that a greater air volume per time unit can enter the room via the opening 151. This would cause the atmospheric environment in the vicinity of the first opening 151 to be influenced more significantly than the atmospheric environment in the vicinity of the second opening 152.

A combination of the possibilities (1) and (2) is also conceivable.

The method (1) offers the possibility of influencing the atmospheric environment in the room more precisely. However, a separate channel from the fan to the opening must be installed for each outlet opening. The fan itself and the installation and maintenance overheads of the channels leading from the fan to the individual openings are relatively expensive. In method (2), a shared channel from the fan can be used at first, branching off to the individual outlet openings at a suitable point. The fan generates a single airflow, which arrives at the openings via the branches.

Using the control and regulation unit 110, it is therefore possible in general terms to adjust the airflow that enters the room through each opening 151, 152, either by adjusting the individual airflows according to method (1) or by adjusting the openings 151, 152 according to method (2). This adjustment initially relates solely to the air volume per time unit entering the room through the respective outlet opening 151, 152. Moreover, the control and regulation unit 110 influences the fan 140 in such a way as to selectively adjust the atmospheric environment of the airflow L generated by the fan 140 or the atmospheric environment of the individual airflows L1, L2.

The control and regulation unit is therefore designed to control and/or regulate the fan such that the atmospheric environment and the strength of the airflow correspond to specified parameters.

The sensor devices 120, 130 of the air-conditioning device 100 are used to determine these parameters. The sensor devices 120, 130 are configured to detect the presence and possibly the concentration of an analyte in the room 10, i.e. ultimately the air quality, as well as a spatial distribution of the air temperature and air humidity if applicable. The analyte may be e.g. one of the substances cited above in connection with the evaluation of the air quality, e.g. a gas such as CO2, or generally a largely gaseous medium such as gas, fumes, vapor, an aerosol, mist, smoke, etc.

The structure of the sensor devices 120, 130 is explained by way of example with reference to the example of the first sensor device 120. The sensor device 120 is recessed into the wall 11 of the room 10 and has a hollow space 121 which can be filled e.g. with methane (e.g. <5 percent by volume). The hollow space 121 contains a transmit/receive unit 122 including a radiation source 123 which emits electromagnetic radiation L, in particular light, in the visible or non-visible frequency range, and a detector 124 that is sensitive to the frequency of the emitted radiation, e.g. a photodetector or photodiode. The radiation source 123 can be a laser diode or an LED, for example. The output signal of the detector 124, which is dependent on the light quantity or intensity falling on the detector 124, is supplied to the control and regulation unit 110, where it is evaluated for the purpose of controlling and/or regulating the fan 140.

When the light beam L strikes a boundary of the room 10 to be monitored, e.g. the wall opposite to the sensor device 120 in the room, it is diffusely reflected. The light coming back is measured by the detector 124, e.g. a suitable convergent lens system 125 allowing the light from a sufficiently large room angle or room region to be detected.

Expressed in general terms, the detector 124 is arranged such that at least part of the radiation which is emitted by the radiation source 123 during operation can fall directly or indirectly onto the detector 124, i.e. possibly as light that has been scattered back and/or reflected.

The laser diode 123 emits a light beam having a frequency at which the gas to be detected in the room exhibits a significant absorption. This occurs at a wavelength of4.2 μm in the case of CO2, for example. Therefore if the light beam L traverses a region of the room 10 in which an analyte 20 is situated, the light is at least partially absorbed and possibly scattered, such that the detector 124 detects a smaller quantity of light. The attenuation of the light is a direct measure of the number of molecules situated in the light path. The corresponding output signal A₁₂₀ of the detector 124 therefore differs from an output signal or reference signal Ref ₁₂₀ that is measured when no analyte is situated in the beam path.

In order to establish where the analyte is located in the room, the radiation source 123 is now configured such that the emitted radiation can be emitted on a plurality of different beam paths S_{120,i} (where i=1,2,3, . . . ) through the room that can be set or in specific propagation directions that can be set.

The attenuation of the light is measured by the detector 124 for each beam path S_{120,i}, i.e. an output signal A_{120,i} assigned to the corresponding beam path S_{120,i} is determined in each case. From the analysis of the output signals A_{120,i} for the various beam paths S_{120,i}, it is possible to determine the direction in which the analyte is situated as seen from the sensor device 120. During the analysis, e.g. the respective measured output signal A_{120,i} is compared with the corresponding reference signal Ref_{120,i} for the respective beam path S_{120,i}, the reference signal Ref_{120,i} having been measured in the context of a calibration of the sensor device 120 during the installation of the air-conditioning device 100, for example, when no analyte was situated in the beam path S_{120,i}.

Depending on the sensitivity of the sensor unit, the output signal can be used to distinguish whether the analyte is situated in the beam path, or even to infer the concentration of the analyte. In the latter case, it would not suffice merely to establish whether the output signal differs significantly from the corresponding reference value. Rather, it would be necessary quantitatively to determine the difference between the output signal and the reference value, in order to calculate the concentration therefrom, e.g. with reference to the calibration.

In the specific case illustrated in FIG. 1, only the output signal A_{120,4} would be reduced relative to the corresponding reference signal Ref _{120,4} of the beam path S_{120,4}, i.e. A_{120,4}<Ref_{120,4}, while the remaining output signals A_{120,1} A_{120,2} A_{120,3} and A_{120,5} correspond to the reference signals Ref_{120,1} Ref_{120,2} Ref_{120,3} and Ref_{120,5}, with the exception of noise interference, etc. The presence of an analyte in the beam path S_{120,4} could therefore be assumed.

The opening angle or the divergence of the radiation emitted on the beam paths may be restricted in order to achieve high spatial resolution, such that many individual light beams can be emitted accordingly on different beam paths without adjacent light beams overlapping. In the extreme case, the radiation source 123 emits a needle beam, i.e. a light beam L having a divergence of e.g. 1-3°.

In purely arithmetic terms, assuming a divergence of 2°, fifty individual light beams could then be emitted by the sensor device 120 on fifty beam paths Sᵢ (i=1,2, . . . , 50) in order to monitor a room angle of e.g. 100°, without any two adjacent beam paths Sᵢ, Sᵢ₊₁ overlapping.

All of the various beam paths Sᵢ may lie on one plane, e.g. on the horizontal.

The second of the sensor devices 130 shown in FIG. 1 can be designed in an identical manner and function in a fundamentally identical manner to the first sensor device 120 as described above. A radiation source 133 of the second sensor device 130 therefore likewise emits light beams on a plurality of different beam paths S_{130,i}. A detector 134 of the second sensor device 130 detects light that is scattered back and/or reflected, and generates an output signal A_{130,i}, which is compared with a reference signal Ref_{130,i}, for each beam path S_{130,i}.

In order to ensure that the first and the second sensor device 120, 130 can be operated simultaneously without mutual interference, the frequency of the radiation emitted by the radiation source 123 of the first sensor device 120 should differ from the frequency of the radiation emitted by the radiation source 133 of the second sensor device 130. In this case, it must be taken into consideration that the analyte to be detected only absorbs radiation in a specific frequency range, i.e. both frequencies must lie in this frequency range.

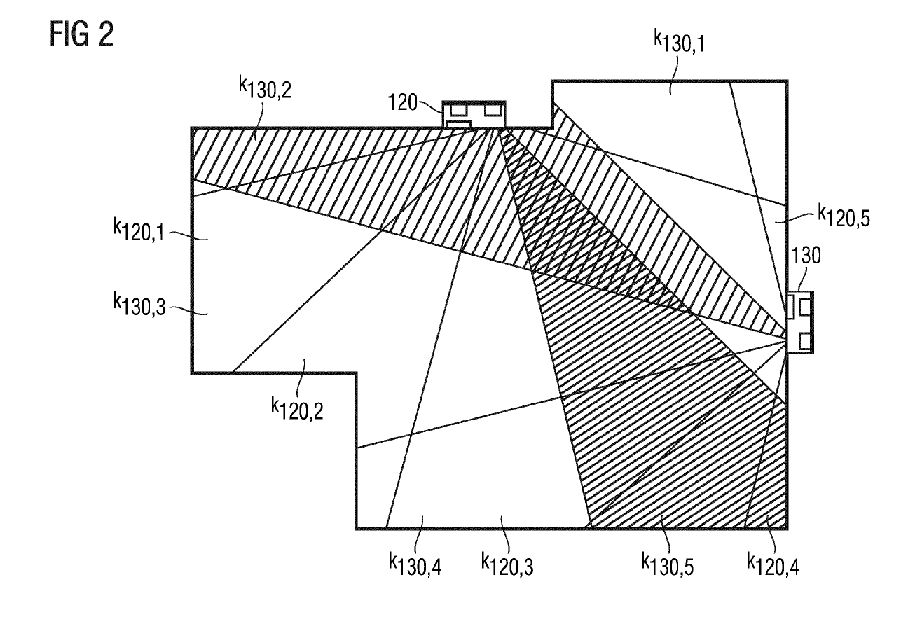

The second sensor device 130 is arranged at a different position than the first sensor device 120, in particular on a different wall. It is thereby possible firstly to ensure that regions of the room which cannot be seen by the first sensor device 120, e.g. due to corners or even furniture, etc. in the beam path, can be monitored by the second sensor device 130. Secondly, the use of the second sensor device 130 allows the generation of a two-dimensional map of the room in respect of the presence and/or concentration of the analyte, e.g. by applying tomographic methods. In other words, the location at which the analyte is situated in the room, if applicable, can be established in two dimensions by two sensor devices 120, 130 that are installed at two different locations. This is illustrated by way of example in FIG. 2 in the form of a two-dimensional map of the distribution of the analyte in the room (the actual position of the analyte is illustrated by the hatching). If only a single sensor device 120 is used, the location can naturally be determined in only one dimension. However, two-dimensional detection requires that the beam paths S_{120,i}, S_{130,i} created by the two sensor devices 120, 130 should ideally be on one and the same plane, and at least on essentially identical planes. The positions of the planes do not have to match exactly, since it is assumed that the analyte has a three-dimensional extent. This means that both a slight misalignment between the planes and a slight offset of the planes in the direction of a normal vector of one of the planes can be tolerated.

In the specific case illustrated in FIG. 1, the output signal A_{130,2} would be reduced relative to the corresponding reference signal Ref_{130,2} of the beam path S_{130,2}, while the remaining output signals A_{130,1} A_{130,3} A_{130,4} and A_{130,5} with the exception of noise interference, etc. would correspond to the associated reference signals Ref_{130,1} Ref_{130,3} Ref_{130,4} and Ref_{130,5}. It would therefore be assumed that the analyte is located in the beam path S_{130,2}.

With reference to the information determined by the first sensor device 120, that the analyte is situated in the beam path S_{120,4}, a two-dimensional map of the space, depicting the distribution of the analyte 20, can be calculated in the control and regulation unit 110.

A corresponding map is illustrated in the FIG. 2. The different beam paths S_{120,i} and S_{130,i} in the map are assigned corridors K_{120,i} and K_{130,i} which are arranged symmetrically around the respective beam path. For the purpose of creating the map, it has been assumed that the radiation sources 123, 133 in each case emit light beams having a comparatively wide divergence which corresponds to exactly the angle separation between two adjacent beam paths of the respective sensor unit (the divergence is therefore understood to be the opening angle of the light cone that is emitted by the radiation source). If the divergence is smaller than the angle separation of the adjacent beam paths, a dead region that cannot be scanned by the respective sensor is produced between two beam paths and the associated corridors.

In the map according to FIG. 2, the region in which the analyte must be situated, i.e. the intersection region of the corridors K_{120,4} and K_{130,2}, is cross-hatched and marked in bold outline.

In the case of a real air-conditioning device, in which it is anticipated that not just five (as per FIG. 1) but considerably more different beam paths per sensor unit will be scanned, the corridors K are considerably narrower and therefore a greater spatial resolution can be achieved.

As soon as the position of the analyte 20 is known, i.e. as soon as the relevant corridor in which the analyte is situated has been identified in the control and regulation unit 110 for each sensor device 120, 130, the control and regulation unit 110 can activate the fan 140, using the knowledge of the positions of the outlet openings 151, 152, such that the atmospheric environment in the room 10 is influenced locally, i.e. at the location where the analyte is situated in particular.

The operation of the suction openings 153, 154 takes place in a similar manner to the operation of the outlet openings 151, 152 as described above, i.e. the position of the analyte 20 is determined by the sensor devices 120, 130 and the control and regulation unit 110 controls/regulates the fan 140 in such a way that the analyte is sucked out via the closest suction opening. It is also possible to provide an additional fan 140′ for operating the suction openings (FIG. 1).

It is also possible e.g. to omit the dedicated suction openings 153, 154 and the corresponding channels 143, 144 without having to forgo the possibility of sucking the analyte out of the room. An airflow could be generated in both directions via the channels 141, 142 and the openings 151, 152 by the fan 140 in this case.

In the simplest case, the control and regulation unit 110 controls the fan 140, 140′ in such a way that an airflow is generated at least via that outlet opening or suction opening which is closest to the detected analyte. If the analyte is situated between two openings, both openings can be used to produce an airflow. The distance between the respective opening and analyte, for example, can be used as a criterion for selecting the opening that is to be used, or specifying the airflow that is to be generated via the respective opening.

The aforementioned observation in respect of the mutual position of the planes of the beam paths applies in the event that the sensor devices 120, 130 adjusts the beam paths S_{120,i}, S_{130,i} only one-dimensionally on a plane, e.g. on the horizontal. If the sensor devices 120, 130 are capable of adjusting the beam paths S_{i,120}, S_{i,130} not just one-dimensionally on a plane in each case, but two-dimensionally, i.e. also on the vertical, it is possible to achieve three-dimensional detection of the position of the analyte.

The above observation applies not only to the presence of a gas or similar in the room, i.e. to the monitoring of the air quality, but also to the determination of other parameters in respect of atmospheric environment such as temperature and/or air humidity. These parameters also have an influence on the absorption and scattering properties of the air, such that a reduction of the output signal A_{120,i} relative to the corresponding reference signal Ref_{120,i} of the beam path S_{120,i} may also be expected in the case of the first sensor device 120, for example.

Various approaches for setting the different beam paths Sᵢ are conceivable. For example, the complete radiation source 123, 133 could be pivoted by a suitable device, such that the directed radiation emitted by the source is directed on the different beam paths Sᵢ. This design is readily conceivable in the case of an LED, for example. If the radiation source is a laser or similar, however, it would be comparatively resource-intensive to pivot the complete radiation source. Alternatively the radiation source itself, i.e. the laser or the LED, could be immovably installed and the radiation that is consequently emitted in a fixed direction by the source is redirected onto the various beam paths Sᵢ by a mobile mirror or the like.

In both of the cases outlined above, one-dimensional or even two-dimensional scanning of the room can be realized by a corresponding number of axes about which the radiation source or the mirror can be pivoted.

In the case of a pivotable radiation source or a pivotable deflection device which is situated in front of a fixed radiation source, the individual radiation paths are selected or scanned sequentially, i.e. in a temporally consecutive manner. In an alternative embodiment, a plurality of radiation paths (even ultimately all radiation paths) of a sensor unit are scanned simultaneously, i.e. a plurality of light beams are emitted in various directions simultaneously. Accordingly, the light that is scattered back from the different beam paths also strikes the detector virtually simultaneously. In order to ensure that the light portions scattered back from the different beam paths Sᵢ can be distinguished from each other, the light beams on the various beam paths Sᵢ are emitted on different frequencies fᵢ. In this case, it must be taken into consideration that the analyte to be detected only absorbs the radiation in a specific frequency range, i.e. the frequencies fᵢ must all lie in this frequency range.

As shown in the figures, the openings 151, 152, 153, 154 are provided in the side walls of the room. However, it is also conceivable to provide openings in the ceiling and/or the floor. The term “wall” is therefore understood to encompass both the side walls and the floor and ceiling of the room accordingly.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-14. (canceled)

15. An air-conditioning device for influencing the atmospheric environment in a room, comprising:
a control and regulation unit; and
at least one sensor device, each including
a radiation source emitting, during operation, radiation into the room on a beam path having a propagation direction pivotable over at least part of the room, such that various radiation paths through the room can be set, and
a detector, arranged such that at least part of the radiation emitted by the radiation source and diffusely reflected in the room during operation can fall directly or indirectly onto the detector which is sensitive to at least the radiation, the detector producing at least one output signal for the radiation paths that can be set, dependent on presence and/or concentration, in the beam path, of a specific analyte that is to be detected, and on a light quantity or an intensity of the radiation which falls on the detector, the control and regulation unit configured to control and/or regulate the air-conditioning device as a function of the output signal of the detector.

16. The air-conditioning device as claimed in claim 15, wherein the at least one output signal includes a corresponding output signal for each of the various radiation paths that can be set.

17. The air-conditioning device as claimed in claim 16, wherein the radiation source emits the radiation on at least some of the various radiation paths simultaneously and frequencies of the radiation vary according to the radiation path.

18. The air-conditioning device as claimed in claim 16, wherein the various radiation paths are sequentially set.

19. The air-conditioning device as claimed in claim 18, wherein at least two of the at least one sensor device are positioned at different locations in the room.

20. The air-conditioning device as claimed in claim 19, wherein the control and regulation unit calculates a two-dimensional map of the analyte in the room, from output signals produced by the at least two sensor devices.

21. The air-conditioning device as claimed in claim 20, wherein the at least two sensor devices operate at different frequencies.

22. The air-conditioning device as claimed in claim 21, wherein the room has a plurality of side walls, a floor and a ceiling, and at least two radiation sources are positioned on different walls of the room

23. The air-conditioning device as claimed in claim 21, wherein the room has a plurality of side walls, a floor and a ceiling, and at least two radiation sources are positioned on a single wall of the room.

24. The air-conditioning device as claimed in claim 21, wherein the radiation paths which can be set by at least two radiation sources lie essentially on a horizontal plane.

25. The air-conditioning device as claimed in claim 24,
wherein the air-conditioning device further comprises:
a device generating at least one airflow into the room during operation, the at least one airflow adjustable in respect of atmospheric environment; and
at least one outlet opening, via which the at least one airflow is directed into the room, and
wherein the control and regulation unit adjusts the at least one airflow coming into the room from the at least one outlet opening as a function of the output signals of the detector as determined for the various radiation paths.

26. The air-conditioning device as claimed in claim 25, wherein the device generating the at least one adjustable airflow generates separate airflows in separate channels corresponding to respective outlet openings.

27. The air-conditioning device as claimed in claim 24,
wherein the air-conditioning device further comprises
a device generating at least one airflow out of the room during operation; and
at least two suction openings via which the at least one airflow can be sucked out of the room,
wherein the control and regulation unit adjusts the airflow leaving the room through the at least two suction openings as a function of the output signals of the detector as determined for the various radiation paths.

28. The air-conditioning device as claimed in claim 27, wherein the device generating the at least one airflow generates separate airflows in separate channels, corresponding to respective suction openings.

29. The air-conditioning device as claimed in claim 24, wherein the radiation source is one of a laser diode and an LED.

30. The air-conditioning device as claimed in claim 29, wherein the frequency of the radiation emitted by the radiation source is selected so that the radiation is at least partially absorbed and/or scattered when it passes through the analyte.
